(19) United States
(12) Patent Application Publication
(10) Pub. No.: US 2026/0268000 A1
(43) Pub. Date: Sep. 10, 2026

(54) METHOD AND SYSTEM FOR CREATING A TAMPERPROOF OPERATING DATA SET

(71) Applicant: DEUTA-WERKE GmbH, Bergisch Gladbach (DE)

(72) Inventor: Sönke BRANDT, Cologne (DE)

(21) Appl. No.: 19/474,635

(22) PCT Filed: Apr. 14, 2023
(86) PCT No.: PCT/EP2023/059838

§ 371 Date: Oct. 10, 2025

(51) Int. Cl. G06F 21/60

(52) U.S. Cl. CPC G06F 21/602

(57) ABSTRACT

The invention is based on a method for creating a tamperproof operating data set during operation of a display device (10a-c, 200d), comprising:-transmitting input data to a computing unit (14a-c, 202d) for the purpose of generating output data that can be displayed,—transmitting the output data to a checking unit (20a-c, 203d),—transmitting the input data to the checking unit (20a-c, 203d),—generating comparison data from a comparison of the input data with the output data by way of the checking unit (20a-c, 203d). It is proposed that the method comprises compiling data to form an operating data set, which comprises at least two of the following three types of data, specifically input data, output data and/or comparison data, by way of a cryptography component (32a-c, 212d) and tamperproofing the operating data set by way of the cryptography component (32a-c, 212d) for the purpose of providing

The invention relates generally to graphical user interfaces (GUI) in applications which safety in the sense of hazard-related or operational safety or functional safety is crucial.

### TECHNICAL BACKGROUND

The invention relates in particular to a monitoring unit for safely presenting image data by means of a presenting computing unit, in particular image computing unit, that is to be classified as unsafe. The presentation of information in the form of computer graphics is susceptible to errors. For example, errors may occur in each individual component of the graphics-generating computing unit, in particular image computing unit, for example owing to a defective microprocessor, in the graphics processor, in the individual memory modules, in the voltage supply, but in particular also owing to software errors in the operating system, in libraries used in the software production process, and in particular in the application software, or other software components, which generates or generate the GUI. A significant improvement is offered by the technology available under the trade names IconTrust® or SelectTrust® for presenting safety-relevant information in accordance with the principle from WO 2011/003872 A1 or the patent EP 2 353 089 B1 or the patent EP 3 712 770 B1 or the first application EP 2 273 369 A1 or EP 2 551 787 B1 from the applicant. This technology allows safer presentation or entry, and is for example suitable for the safety level SIL-2 or higher. A major advantage consists in that hardware and software, of virtually any type and complexity, which is to be classified as not safe (hereinafter referred to for short as unsafe) in the context of safety technology, can be used in a provably safe manner by equipping such hardware with a separate, safety-certified monitoring module.

### PROBLEM

A first problem addressed by the present invention is that of proposing a further-developed method in accordance with the principle from WO 2011/003872 A1 or the patent EP 2 353 089 B1 which in particular allows a safety-relevant export of operating data sets and allows tamperproof archiving and/or storage of operating data sets.

### GENERAL DESCRIPTION OF THE INVENTION(S)

According to a first independent aspect, the invention proceeds from a method for creating a tamperproof operating data set during operation of a display device, the method comprising:
transferring input data to a computing unit in order to generate presentable output data,
transferring the output data to a checking unit,
transferring the input data to the checking unit,
generating, by means of the checking unit, comparison data from a comparison of the input data with the output data.

According to the first independent aspect of the invention, it is proposed that the method comprises compiling data to form the operating data set, which comprises at least two of the following three data, specifically input data, output data and/or comparison data, by means of a cryptography component, and tamperproofing the operating data set by means of the cryptography component in order to provide a tamperproof operating data set.

The display device preferably comprises at least one display unit, in particular at least one display and/or at least one touchscreen display. The display device preferably comprises at least one computing unit, in particular an image computing unit. The display device preferably comprises at least one further computing unit, in particular a checking unit. The display device preferably comprises at least one additional computing unit, in particular a data set generator. The additional computing unit, in particular the data set generator, preferably comprises the cryptography component. The display device may comprise at least one auxiliary computing unit, in particular a safe computing unit, preferably a safety programmable controller (SPC). The auxiliary computing unit may be formed externally, in particular separately, with respect to the display device. The computing unit, the further computing unit and/or the additional computing unit may be formed at least in part as one component, in particular on a common board, in particular circuit board. For example, the further computing unit, in particular the checking unit, and the additional computing unit, in particular the data set generator, may be formed as one computing unit, in particular as one safety system, preferably on a common board or circuit board, which is formed and/or arranged separately from, preferably as a separate component with respect to, the computing unit, in particular the image computing unit, and/or as a separate component with respect to the auxiliary computing unit.

Preferably, in at least one method step, input data, in particular safe input data, are transferred to the computing unit, in particular image computing unit, in order to generate presentable output data. The input data are preferably configured in the form of process values. The input data are preferably generated by the safe computing unit, in particular the safety programmable controller (SPC), in particular the auxiliary computing unit. Preferably, in at least one method step, the computing unit, in particular image computing unit, generates presentable output data, in particular image data, preferably for pixel-based presentation, from the input data. The computing unit is preferably connected to at least one display unit, for example the display, of the display device, in particular for a transfer of the output data in the form of image data to the display unit. A computing unit comprises in particular a processor and/or a processor unit, a memory unit, and may comprise an operating, control and/or calculation program stored in the memory unit. The computing unit, in particular the image computing unit, preferably comprises at least one GPU as processor. The display device preferably comprises at least one recovery unit, which is preferably configured as a computing unit, and which is designed to determine a process value, via fingerprint data, from output data, in particular image data, generated by the image computing unit. For example, the recovery unit may be formed as part of the further computing unit, in particular the checking unit. For example, the recovery unit may be formed as part of the computing unit, in particular the image computing unit. The recovery unit is preferably designed to convert the output data in the form of image data, in particular video data, into fingerprint data and/or into at least one process value. Fingerprint data may for example be configured as hashed data. For example, the recovery unit may be formed as a component which is separate or different, in particular non-destructively spatially separable, from the checking unit and/or the image computing unit and/or the data set generator.

Preferably, in at least one method step, the output data are transferred, for example in the form of a process value recovered from the output data, preferably in the form of image data, from the computing unit, preferably from the image computing unit, to the checking unit. Preferably, in at least one method step, the output data are transferred, for example in the form of a process value recovered from the output data or in the form of fingerprint data recovered from the output data or for example in the form of image data, from the image computing unit or the recovery unit to the data set generator.

Preferably, in at least one method step, the input data, in particular safe input data, are transferred directly from the auxiliary computing unit, preferably the safe computing unit, in particular a safety programmable controller (SPC), to the checking unit.

The checking unit preferably comprises a comparison component for comparing the input data with the output data. Preferably, in at least one method step, the checking unit generates the comparison data from a comparison of the input data with the output data, in particular for the purposes of initiating a safety-oriented reaction. The further computing unit, in particular the checking unit, is preferably designed such that, in the presence of at least an irregularity in the comparison data, said checking unit initiates a safety-oriented reaction, for example a restart. Preferably, in at least one method step, the comparison data are transferred from the further computing unit, in particular the checking unit, to the additional computing unit, in particular the data set generator. Preferably, in at least one method step, the additional computing unit, in particular the data set generator, compiles the operating data set with operating data relating to the display device. Preferably, in at least one method step, the additional computing unit, in particular the data set generator, compiles a plurality of operating data sets relating to the display device, preferably at periodic time intervals relative to one another.

Each operating data set preferably comprises the same data entry fields. Preferably, each operating data set comprises either at least the input data and the output data, at least the comparison data and the output data, and/or the input data and the comparison data. Each operating data set may comprise signature data that are created from all data, for example from the input data, the output data and/or the comparison data, of the particular operating data set, in particular by means of a hashing algorithm.

The additional computing unit, in particular the data set generator, for example the cryptography component, preferably has a data backup interface, which is designed to enable the at least one operating data set to be output. The data backup interface may be configured as a wireless interface, in particular for wireless data transfer.

Each computing unit may be or comprise a configurable logic unit/configurable logic units or a programmable computer component/programmable computer components such as an FPGA, ASIC and/or microcontroller. An implementation in the form of logically separate computing components by means of common hardware, in particular in one integrated circuit, also falls within the scope of the invention.

The data set generator may, for the transfer of the input data, be connected to the safe computing unit via a connection arranged outside the image computing unit. The data set generator may, for the transfer of the input data, be connected to the safe computing unit by means of the image computing unit.

Preferably, in at least one method step, anti-tamper protection, for example a cryptographic signature, is imparted to at least one operating data set. Anti-tamper protection is to be understood in particular to mean relative anti-tamper protection, which can serve to make data sets checkable for tampering, wherein, in particular, the anti-tamper protection does not rule out tampering of the data.

In at least one method step, at least one operating data set may be at least partially encrypted in order to achieve anti-tamper protection for the operating data set. In at least one method step, the signature data, for example hashed data, may be formed from the other data in the at least one operating data set. In at least one method step, the signature data may be encrypted in order to achieve anti-tamper protection for the operating data set. In at least one method step, the signature data, for example hashed data, may be formed by means of a hashing algorithm. Preferably, for example in at least one method step, a digital signature, preferably cryptographic signature, is created for at least one operating data set and is appended to the corresponding at least one unencrypted operating data set in order to achieve anti-tamper protection for the operating data set.

The cryptography component is preferably configured as a secure element IC or security co-processor IC, wherein IC stands in particular for integrated circuit.

By means of the embodiment of the method according to the invention, advantageous data provision can be achieved, which in particular is suitable for making operating data accessible over the long term. A high safety standard can advantageously be achieved. Advantageous anti-tamper protection for the operating data sets can be achieved. In particular, advantageous certified documentation of the processes during operation of the display device can be achieved. In particular, the method can lead to functionally safer HMIs and can advantageously lessen the burden on operators with regard to communication and documentation. In particular, through resulting risk reduction and/or by means of the certified documentation, it is possible to achieve further advantages on a system level.

It is also proposed that the image data comprise video data. It is possible to realize an advantageously multicompatible file format for archiving.

It is also proposed that the output data are transferred, in the form of image data, to the cryptography component. The computing unit, in particular the image computing unit, is preferably directly connected to the data set generator, in particular the cryptography component, for data transfer. Preferably, in at least one method step, the image data are transferred from the computing unit, in particular image computing unit, to the data set generator. Preferably, in at least one method step, the image data are incorporated as output data into the operating data set. An advantageously uncomplicated reconstruction of an operation of the display device can thus be achieved using the output data in the operating data set. Checking of a table for converting fingerprint data into process values can advantageously be avoided.

It is also proposed that the output data are transferred, in the form of fingerprint data generated from image data by a computing unit, in particular the aforementioned computing unit, and/or a further computing unit, in particular the aforementioned further computing unit, preferably the recovery unit, to the cryptography component. The computing unit, in particular the image computing unit, and/or the further computing unit, in particular the checking unit, and/or preferably the recovery unit, is preferably directly connected to the data set generator, in particular the cryptography component, for data transfer. Preferably, in at least one method step, the output data are transmitted, in the form of fingerprint data, from the computing unit, in particular image computing unit and/or the further computing unit, in particular the checking unit, and/or preferably the recovery unit, to the data set generator, in particular the cryptography component. Preferably, in at least one method step, the output data in the form of image data are converted into fingerprint data, preferably by means of the computing unit, in particular the image computing unit, and/or the further computing unit, in particular the checking unit, preferably by means of the recovery unit. Preferably, in at least one method step, the fingerprint data are incorporated as output data into the operating data set. An advantageously reduced data volume of the output data in the operating data set can be achieved. Checking of a table for converting fingerprint data into process values can advantageously be avoided.

It is also proposed that the output data are transferred, in the form of a process value generated from image data by a computing unit, in particular the aforementioned computing unit, and/or a further computing unit, in particular the aforementioned further computing unit, particularly preferably by means of the recovery unit, to the cryptography component. Preferably, in at least one method step, the output data are transmitted from the further computing unit, in particular checking unit, preferably the recovery unit, in particular as part of the checking unit, to the data set generator, in particular the cryptography component.

Preferably, in at least one method step, the output data in the form of image data are converted into fingerprint data and/or process values, preferably by means of the computing unit and/or the further computing unit, particularly preferably by means of the recovery unit. Preferably, in at least one method step, at least one process value is incorporated as output data into the operating data set. An advantageously reduced data volume of the output data in the operating data set can be achieved.

It is also proposed that, in the compiling of the operating data set, all three of the following data, specifically the comparison data, the output data and the input data, are incorporated into the operating data set. Each operating data set particularly preferably comprises the input data and the output data and the comparison data. It is particularly preferable if, in at least one method step, at least the input data and the output data and the comparison data are combined to form an operating data set. An advantageously comprehensive operating data set can be created.

A second problem addressed by the present invention is that of proposing a further-developed method in accordance with the principle from the patent EP 2 551 787 B1 which in particular additionally allows a safety-relevant export of operating entered-data sets and additionally allows tamperproof archiving and/or storage of operating entered-data sets.

According to a second independent aspect, the invention proceeds from a method for creating a tamperproof operating entered-data set during operation of a display device having a display unit and having an entry unit arranged on the display unit, the method comprising:
transferring input data to a computing unit, in particular to an image computing unit, in order to generate presentable output data,
transferring the presentable output data to a checking unit,
capturing an entry, for example a touch entry, made at the entry unit by reading out the entry unit as entered data,
transferring the entered data to the checking unit,
generating, by means of the checking unit, entry verification data from a merging at least of the entered data and the output data.

According to the second independent aspect of the invention, it is proposed that the method comprises
merging data to form the operating entered-data set from the entry verification data and the entered data by means of a cryptography component, and
tamperproofing the operating entered-data set by means of the cryptography component in order to provide a tamperproof operating entered-data set.

The display device preferably comprises at least one touchscreen display. Preferably, the at least one touchscreen display is formed by the display unit and the entry unit arranged on the display unit. Alternatively or in addition, the entry unit may be or have a mouse, keyboard, control console or the like. The display unit is preferably a display. The display device preferably comprises at least one computing unit, in particular the image computing unit. The display device preferably comprises at least one further computing unit, in particular a checking unit. The display device preferably comprises at least one recovery unit, which is preferably configured as a computing unit, and which is designed to determine a process value, via fingerprint data, from output data, in particular image data, generated by the image computing unit. For example, the recovery unit may be formed as part of the further computing unit, in particular the checking unit. For example, the recovery unit may be formed as part of the computing unit, in particular the image computing unit. The recovery unit is preferably designed to recover, from the output data, a process value relating to a verification of the displayed output data with the input data, in particular relating to a check of the work done by the image computing unit. The recovery unit is preferably designed to convert the output data in the form of image data, in particular video data, into fingerprint data and/or into at least one process value. Fingerprint data may for example be configured as hashed data. For example, the recovery unit may be formed as a component which is separate or different, in particular non-destructively spatially separable, from the checking unit and/or the image computing unit and/or the data set generator.

The display device preferably comprises at least one additional computing unit, in particular a data set generator. The additional computing unit, in particular the data set generator, preferably comprises the cryptography component.

The display device may comprise at least one auxiliary computing unit, in particular a safe computing unit, preferably a safety programmable controller (SPC). The computing unit, the further computing unit and/or the additional computing unit may be formed at least in part as one component, in particular on a common board, in particular circuit board. For example, the further computing unit, in particular the checking unit, and the additional computing unit, in particular the data set generator, may be formed as one computing unit, in particular as one safety system, preferably on a common board or circuit board, which is formed and/or arranged in particular separately from, preferably as a separate component with respect to, the computing unit, in particular the image computing unit, wherein, in particular, the recovery unit is formed as part of the checking unit.

Preferably, in at least one method step, input data, in particular safe input data, are transferred to a computing unit, in particular to the image computing unit, in order to generate presentable output data. The input data are preferably configured in the form of process values. The input data are preferably generated by a safe computing unit, in particular a safety programmable controller (SPC), in particular the auxiliary computing unit. Preferably, in at least one method step, the computing unit, in particular the image computing unit, generates presentable output data, in particular image data, preferably for pixel-based presentation, from the input data. The computing unit, in particular the image computing unit, is preferably connected to at least one display unit of the display device, in particular for a transfer of the output data to the display unit.

Preferably, in at least one method step, the output data are transferred, for example in the form of image data, from the computing unit, preferably from the image computing unit, to the checking unit. For example, in at least one method step, the output data are transferred, for example in the form of a process value recovered from the output data in the form of image data, from the recovery unit, preferably as part of the image computing unit, to the checking unit. For example, in at least one method step, the output data are transferred, for example in the form of fingerprint data recovered from the output data in the form of image data, from the recovery unit, preferably as part of the image computing unit, to the checking unit.

In at least one method step, the input data, in particular safe input data, may be transferred directly from the auxiliary computing unit, preferably safe computing unit, in particular the safety programmable controller (SPC), to the checking unit. Preferably, in at least one method step, the entered data are captured by the entry unit. Preferably, in at least one method step, the entered data are transferred to the checking unit. Preferably, in at least one method step, the entered data are transferred to the data set generator. The checking unit preferably comprises a comparison component for comparing the input data with the output data. Preferably, in at least one method step, the checking unit generates comparison data from a comparison of the input data with the output data, in particular for the purposes of initiating a safety-oriented reaction. The further computing unit, in particular the checking unit, is preferably designed such that, in the presence of at least an irregularity in the comparison data, said checking unit initiates a safety-oriented reaction, for example a restart of at least a part of the display device. Preferably, in at least one method step, the comparison data are transferred from the further computing unit, in particular the checking unit, to the additional computing unit, in particular the data set generator. In particular, the second aspect of the invention may supplement the first aspect of the invention.

Preferably, the checking unit comprises a, in particular the aforementioned, comparison component for merging at least the entered data and the output data. Preferably, in at least one method step, the checking unit, in particular the comparison component, generates the entry verification data from a merging at least of the entered data and the output data. The entry verification data may for example be understood as data regarding which icon on a presented display was clicked on. Preferably, in at least one method step, the entry verification data are transferred, preferably in the form of a process value, from the further computing unit, in particular the checking unit, to the additional computing unit, in particular the data set generator.

Preferably, in at least one method step, the additional computing unit, in particular the data set generator, compiles the operating entered-data set with operating entered data, and in particular additionally operating data, relating to the display device. Preferably, in at least one method step, the additional computing unit, in particular the data set generator, compiles a plurality of operating entered-data sets relating to the display device, preferably every time an entry is captured and/or at periodic time intervals relative to one another. Each operating entered-data set preferably comprises the same data entry fields.

The additional computing unit, in particular the data set generator, for example the cryptography component, preferably has a data backup interface, which is designed to enable the at least one operating entered-data set to be output. The data backup interface may be configured as a wireless interface, in particular for wireless data transfer.

The data set generator may, for the transfer of the input data, be connected to the safe computing unit via a connection arranged outside the image computing unit. The data set generator may, for the transfer of the input data, be connected to the safe computing unit by means of the image computing unit. The data set generator may, for the transfer of the entered data, be connected to the entry unit via a connection arranged outside the image computing unit. The data set generator may, for the transfer of the entered data, be connected to the entry unit by means of the image computing unit.

The cryptography component is preferably configured as a secure element IC or security co-processor IC or some other suitable integrated circuit (IC) having an encryption function or cryptographic signature function. The statement that anti-tamper protection is imparted to the operating entered-data set is to be understood in particular to mean that the operating data set is at least partially encrypted, or at least one cryptographic part, in particular a cryptographic signature, is appended to the operating data set. Preferably, in at least one method step, at least one operating entered-data set is at least partially encrypted and/or has a cryptographic signature imparted to it in order to achieve anti-tamper protection for the operating entered-data set. Preferably, in at least one method step, anti-tamper protection, for example a cryptographic signature, is imparted to at least one operating entered-data set. In at least one method step, at least one operating entered-data set may be at least partially encrypted in order to achieve anti-tamper protection for the operating entered-data set. In at least one method step, signature data, for example hashed data, may be formed from the other data in the at least one operating entered-data set. In at least one method step, the signature data of the operating entered-data set may be encrypted in order to achieve anti-tamper protection for the operating entered-data set. In at least one method step, the signature data, for example hashed data, may be formed by means of a hashing algorithm. Preferably, for example in at least one method step, a digital signature, preferably cryptographic signature, is created for at least one operating entered-data set and is appended to the corresponding at least one unencrypted operating entered-data set in order to achieve anti-tamper protection for the operating entered-data set.

By means of the embodiment of the method according to the invention, advantageous data provision can be achieved, which in particular is suitable for making operating entered data accessible over the long term. A high safety standard can advantageously be achieved. Advantageous anti-tamper protection can be achieved for the operating entered-data sets, in particular by making them tamper-evident. In particular, advantageous certified documentation of the processes during operation of the display device can be achieved. In particular, the method can lead to functionally safer HMIs and can advantageously lessen the burden on operators with regard to communication and documentation. In particular, through resulting risk reduction and/or by means of the certified documentation, it is possible to achieve further advantages on a system level.

It is also proposed that, in the compiling of the operating entered-data set, the input data and/or the output data are additionally incorporated. Preferably, in at least one method step, the input data and/or output data are incorporated into the at least one operating entered-data set by means of the additional computing unit, in particular by means of the data set generator. Preferably, in at least one method step, the output data are incorporated, in particular in a data form described with regard to the first aspect of the invention, into the at least one operating entered-data set by means of the additional computing unit, in particular by means of the data set generator. An advantageously comprehensive operating entered-data set can be realized.

It is also proposed that, in the compiling of the operating entered-data set, comparison data created by means of the checking unit from a comparison of the input data with the output data are additionally incorporated. An advantageously comprehensive and at the same time memory-conserving operating entered-data set can be realized.

It is also proposed that, in the creation of the operating data set or of the operating entered-data set, index data, preferably timestamp data, counting data and/or reference data, are additionally incorporated into the operating data set or the operating entered-data set. Preferably, in at least one method step, index data in the form of a timestamp, continuous numbering and/or some other item of reference information are incorporated into the operating data set or the operating entered-data set. Preferably, each operating entered-data set comprises the entered data and the entry verification data and preferably the index data. Each operating entered-data set may additionally comprise the output data, the input data and/or the comparison data. Advantageously checkable completeness of the operating data set and/or the operating entered-data set can be achieved.

It is also proposed that the tamperproofing of the operating data set or of the operating entered-data set is performed by asymmetrical encryption, in particular using an Elliptic Curve Cryptography (ECC) algorithm or a Rivest-Shamir-Adleman (RSA) cryptography algorithm. The tamperproofing, for example of the signature data, is preferably implemented using a private key. The tamperproofing of the operating data set or of the operating entered-data set may be implemented in particular by means of a cryptographic signature on an otherwise unencrypted operating data set. Advantageous anti-tamper protection for the data can be achieved.

It is also proposed that the tamperproof operating data set or the tamperproof operating entered-data set is stored. Preferably, in at least one method step, the at least partially encrypted and/or cryptographically signed operating data set and/or the at least partially encrypted and/or cryptographically signed operating entered-data set is stored on a recorder unit. Advantageous archiving of the operating parameters of display devices can be achieved.

It is furthermore proposed that the method is, at least in part, carried out repeatedly. The entire method preferably runs repeatedly at periodic time intervals such as 10 s, 5 s, 1 s or the like. The entire method preferably runs, preferably in full, every time an entry, made in particular by a user, is captured. Advantageous uninterrupted and in particular memory-conserving archiving of the operating parameters of display devices can be achieved.

Also proposed is a data set generator having a cryptography component. It is proposed that the cryptography component is designed to create an operating data set and/or an operating entered-data set from an operation of a display device, and is designed to impart anti-tamper protection to the operating data set and/or to the operating entered-data set. An advantageous functional expansion can be achieved for existing display devices.

Also proposed is a safety system having a data set generator according to the invention. It is proposed that the safety system comprises a checking unit which is designed to generate entry verification data from a merging at least of entered data and output data, and/or to generate comparison data from a comparison of input data with output data. The safety system preferably comprises the data set generator and the checking unit, in particular as one component, for example on a common board. An advantageous extensive functional expansion can be achieved for existing display devices.

It is also proposed that the safety system comprises a recorder unit which is designed to store the operating data set and/or the operating entered-data set. The recorder unit is preferably configured as a memory chip, a hard disk, a server or the like. The recorder unit may be formed separately from the data set generator. The recorder unit may alternatively be formed externally, in particular separately, with respect to the safety system, in particular the display device. An advantageous export of data with an archive function can be achieved.

It is also proposed that the safety system comprises a data backup interface which is designed to output the operating data set and/or the operating entered-data set. The data backup interface is preferably configured as a wireless interface for data transfer to the recorder unit. In particular, the cryptography component may be connected wirelessly to the recorder unit via the data backup interface. Advantageous data transfer can be achieved.

Also proposed is a display device having a safety system according to the invention. An advantageous safety standard of the display device can be achieved.

Also proposed is an operator control terminal having a display device according to the invention. The operator control terminal may be configured for the control of a machine. The operator control terminal may be arranged directly on machines, in particular as a machine terminal. The operator control terminal may be configured as a field terminal. The operator control terminal may be designed for arrangement in factory halls or for example at loading platforms. The recorder unit may be part of the operator control terminal, in particular may be arranged in the operator control terminal. The auxiliary computing unit may be part of the operator control terminal, in particular may be arranged in the operator control terminal. The recorder unit may alternatively be formed/arranged externally, in particular separately, with respect to the operator control terminal. The auxiliary computing unit may alternatively be formed/arranged externally, in particular separately, with respect to the operator control terminal. An advantageous safety standard of the operator control terminal can be achieved.

Also proposed is a vehicle, in particular rail vehicle, having an according to the invention. The vehicle may be in the form of a passenger car, truck, helicopter, bus, construction site vehicle, for example excavator, roller or bulldozer, aircraft, agricultural vehicle, for example tractor, combine harvester or the like, or preferably a rail vehicle, for example a power car or locomotive. An advantageous safety standard of the vehicle can be achieved.

Also proposed is a signal box for controlling a railway system, having an operator control terminal according to the invention. An advantageous safety standard of the signal box can be achieved.

Also proposed is a control station for process control in an industrial plant, having an operator control terminal according to the invention. An advantageous safety standard of the control station can be achieved.

The method according to the invention, the data set generator according to the invention, the safety system according to the invention, the display device according to the invention, the operator control terminal according to the invention and/or the vehicle, signal box and/or control station according to the invention are not intended to be limited to the use and embodiment described above. In particular, the method according to the invention, the data set generator according to the invention, the safety system according to the invention, the display device according to the invention, the operator control terminal according to the invention and/or the vehicle, signal box and/or control station according to the invention may, in order to perform a function described herein, have a number of individual elements, components and units and method steps which differs from a number stated herein. Furthermore, where value ranges are stated in this disclosure, values lying within the stated limits are also intended to be disclosed and usable as desired.

### BRIEF DESCRIPTION OF THE DRAWINGS

Further advantages will become apparent from the following description of the drawings. The drawings illustrate four exemplary embodiments of the invention. The drawing, the description and the claims contain numerous features in combination. A person skilled in the art will expediently also consider the features individually and combine them to form meaningful further combinations. In the drawings:

FIG. 1 shows a display device according to the invention in a schematic illustration,

FIG. 2 shows a method according to the invention in a schematic illustration,

FIG. 3 shows a second display device according to the invention in a schematic illustration,

FIG. 4 shows a second method according to the invention in a schematic illustration,

FIG. 5 shows a third display device according to the invention in a schematic illustration,

FIG. 6 shows a third method according to the invention in a schematic illustration,

FIG. 7 shows a fourth display device according to the invention in a schematic illustration, and

FIG. 8 shows a fourth method according to the invention in a schematic illustration.

### DESCRIPTION OF THE EXEMPLARY EMBODIMENTS

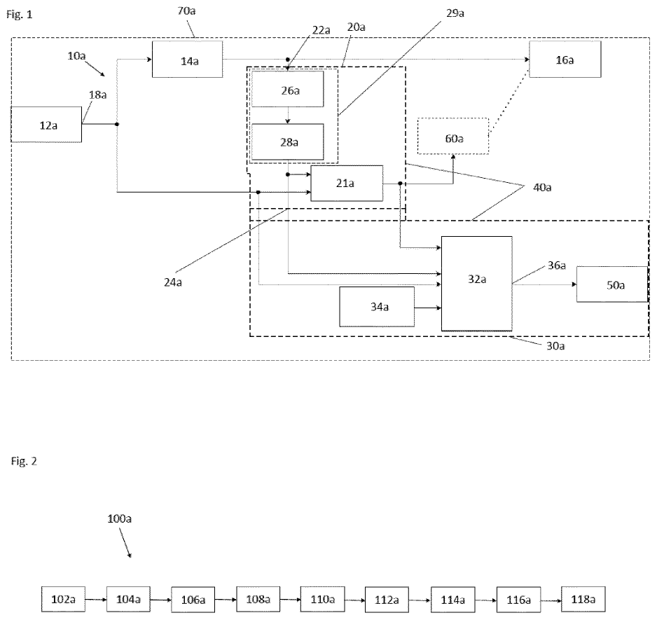

FIG. 1 shows a display device 10a which is designed to carry out a method 100a for creating an operating data set during operation of the display device 10a (cf. FIG. 2).

In this example, an external computing unit 12a, which in particular does not belong to the display device 10a, makes input data available. The external computing unit 12a is a safe computing unit 12a, in particular a safety programmable controller (SPC), which makes input data available that are assumed, for further processes, to be “correct”. In particular, the external, safe computing unit 12a is designed to provide the input data in the form of process values. In particular, the external, safe computing unit 12a has an input interface 18a at which the external, safe computing unit 12a makes the input data available.

The display device 10a comprises an image computing unit 14a, which is in particular a computing unit. The external, safe computing unit 12a is connected to the image computing unit 14a, in particular via the input interface 18a. The image computing unit 14a comprises a GPU as processor.

The display device 10a comprises a display unit, in particular a display 16a, in particular for pixel-based presentation. The image computing unit 14a is designed to convert the input data in the form of process values into output data in the form of image data, in particular for the display 16a. The display 16a is designed to display the image data generated by the image computing unit 14a. The image data generated by the image computing unit 14a may contain errors.

The display device 10a has a checking unit 20a, which is a further computing unit. The image computing unit 14a is designed to transmit the output data to the checking unit 20a. The external, safe computing unit 12a is designed to transmit the input data to the checking unit 20a. In particular, the checking unit 20a is connected to the image computing unit 14a for data transfer. In particular, the checking unit 20a is connected to the external, safe computing unit 12a for data transfer. In particular, the checking unit 20a is a computing unit which is formed separately from the image computing unit 14a and which is in particular arranged on a different board or circuit board. The checking unit 20a is designed to generate comparison data, for example difference data, from a comparison of the input data with the output data. The checking unit 20a has a comparison component 21a for comparing the input data with the output data. The checking unit 20a is designed such that, in the presence of at least an irregularity in comparison data, said checking unit initiates a safety-oriented reaction, for example a restart.

The checking unit 20a comprises an image interface 22a, which is connected to the image computing unit 14a. The checking unit 20a comprises a data set interface 24a.

The display device 10a has a recovery unit 29a, which is designed to convert the output data in the form of image data into fingerprint data and/or process values. The recovery unit 29a has a first recovery component 26a, which is designed to convert the output data in the form of image data into fingerprint data. The recovery unit 29a has a second recovery component 28a, which is designed to convert the output data in the form of fingerprint data into process values. The recovery unit 29a is configured as a computing unit. The recovery unit 29a is configured as part of the checking unit 20a. The recovery unit 29a, in particular the second recovery component 28a, is connected to the comparison component 21a for data transfer.

The display device 10a has an additional computing unit, in particular a data set generator 30a. The data set generator 30a comprises a cryptography component 32a. In particular, the data set generator 30a is a computing unit which is formed separately from the image computing unit 14a and which is in particular arranged on a different board or circuit board. The cryptography component 32a, in particular the entire data set generator 30a, is for example configured as a secure element IC.

The data set generator 30a is connected to the checking unit 20a for transfer of the comparison data and is connected to the recovery unit 29a for transfer of the process values determined by the recovery unit 29a to the data set generator 30a. For example, the checking unit 20a and the data set generator 30a are configured as one safety system 40a on a common board or circuit board, which is in particular formed separately from the image computing unit 14a. The recovery unit 29a, in particular the second recovery component 28a, is connected to the data set generator 30a, in particular the cryptography component 32a, for data transfer.

The data set generator 30a has an index unit 34a. The index unit 34a is designed to provide and/or output index data, for example incremental counter data, for each operating data set. The data set generator 30a is designed to compile at least one operating data set with operating data relating to the display device 10a. The data set generator 30a is designed to compile a plurality of operating data sets relating to the display device 10a at periodic time intervals relative to one another. Each operating data set comprises the same data entry fields. The data set generator 30a is connected to the safe computing unit 12a via a connection arranged outside the image computing unit 14a.

The data set generator 30a comprises, for example on the cryptography component 32a, a data backup interface 36a which is designed to provide the at least one operating data set. The data backup interface 36a is configured as a wireless interface, in particular for wireless data transfer.

The data set generator 30a, in particular the cryptography component 32a, is designed to compile the operating data sets from the input data, the output data, the comparison data and the index data. The data set generator 30a, in particular the cryptography component 32a, is designed to create signature data relating to the input data, the output data, the comparison data and the index data, for example by applying a hashing algorithm.

For example, the signature data are in this case hashed data relating to the other data in the operating data set. In this example, each operating data set comprises the input data, the output data, the index data and the comparison data and signature data. The data set generator 30a, in particular the cryptography component 32a, is designed to append a cryptographic signature to the operating data set, in particular by encrypting the signature data. The data set generator 30a, in particular the cryptography component 32a, is designed to at least partially encrypt the operating data sets, in particular to encrypt at least the signature data of the operating data set, by asymmetric encryption.

The safety system 40a comprises a recorder unit 50a. The recorder unit 50a is designed to store created, cryptographically signed and/or at least partially encrypted operating data sets. The recorder unit 50a is designed to obtain the created, cryptographically signed and/or at least partially encrypted operating data sets from the data set generator 30a, in particular the cryptography component 32a, via the data backup interface 36a.

FIG. 2 schematically shows a method 100a for creating an operating data set during operation of the display device 10a.

In one method step, in particular an input data step 102a, safe input data are transferred to the image computing unit 14a in order to generate presentable output data. In one method step, in particular the input data step 102a, safe input data are transferred, in particular directly from the safe computing unit 12a, to the checking unit 20a, in particular the comparison component 21a. In one method step, in particular the input data step 102a, safe input data are transferred, in particular directly from the safe computing unit 12a, to the data set generator 30a, in particular the cryptography component 32a. The input data are configured in the form of process values. The input data are generated by the safe computing unit 12a.

In one method step, in particular a generation step 104a, presentable output data, in particular image data, are generated from the input data by the image computing unit 14a.

In one method step, in particular an output data step 106a, the output data are transferred from the image computing unit 14a to the checking unit 20a, in particular the comparison component 21a, via the recovery unit 29a. In one method step, in particular the output data step 106a, the output data are transferred from the image computing unit 14a to the display 16a.

In at least one method step, in particular in a recovery step 108a, the output data are converted by the recovery unit 29a, in particular the first recovery component 26a, and the second recovery component 28a, firstly into a fingerprint and then into a recovered process value. In at least one method step, in particular the recovery step 108a, the output data in the form of image data are converted into fingerprint data and/or process values, in particular by means of recovery unit 29a, in particular the first recovery component 26a and/or the further recovery component 28a.

In one method step, in particular in a transmission step 110a, the output data are, in the form of the process value recovered from the output data, transferred from the recovery unit 29a, in particular the first recovery component 26a, and the second recovery component 28a, to the comparison component 21a of the checking unit 20a. In one method step, in particular in the transmission step 110a, the output data are, in the form of the process value generated from image data by the recovery unit 29a, in particular by the second recovery component 28a, transferred, in particular from the second recovery component 28a, to the cryptography component 32a. In at least one method step, in particular in the transmission step 110a, the output data are transferred from the checking unit 20a to the data set generator 30a, in particular the cryptography component 32a. In one method step, in particular the transmission step 110a, the index data are transferred to the data set generator 30a, in particular to the cryptography component 32a, in particular from the index unit.

In the three method steps, the output data step 106a, the recovery step 108a and the transmission step 110a, the output data are, in the form of a process value recovered from the output data, transferred from the image computing unit 14a to the checking unit 20a, in particular the comparison component 21a.

In one method step, in particular a comparison data step 112a, the comparison data are generated by the checking unit 20a, in particular the comparison component 32a, from a comparison of the input data with the output data, in particular for the purposes of initiating a safety-oriented reaction by means of a reaction unit 60a. The reaction unit 60a is part of the display device 10a. The reaction unit 60a is formed separately from the checking unit and the data set generator 30a. The reaction unit 60a may alternatively easily be formed as one component together with the checking unit. In one method step, in particular the comparison data step 112a, the comparison data are transferred from the checking unit 20a, in particular from the comparison component 32a, to the data set generator 30a, in particular the cryptography component 32a.

In one method step, in particular a data set step 114a, the data set generator 30a compiles the operating data set with operating data relating to the display device 10a. In one method step, in particular the data set step 114a, in the compiling of the operating data set, all three of the following data from the comparison data, the output data and the input data are incorporated into the operating data set. In one method step, in particular the data set step 114a, the output data are incorporated in the form of process values into the operating data set. In one method step, in particular the data set step 114a, the index data are incorporated into the operating data set.

In one method step, in particular a protection step 116a, the data set generator 30a, in particular the cryptography component 32a, imparts anti-tamper protection, for example a cryptographic signature, to the operating data set. In one method step, in particular the protection step 116a, the data set generator 30a, in particular the cryptography component 32a, forms the signature data, for example hashed data, from the other data in the operating data set. In one method step, in particular the protection step 116a, the data set generator 30a, in particular the cryptography component 32a, forms the signature data, for example as hashed data, by means of a hashing algorithm. In one method step, in particular the protection step 116a, the data set generator 30a, in particular the cryptography component 32a, at least partially encrypts the operating data set, in particular encrypts the signature data of the operating data set, in order to achieve anti-tamper protection for the operating data set, in particular in order to provide a tamperproof operating data set. In one method step, in particular the protection step 116a, the signature data are encrypted in order to achieve anti-tamper protection for the operating data set. In one method step, in particular the protection step 116a, the signature data, for example hashed data, are formed by means of a hashing algorithm. In one method step, in particular the protection step 116a, a digital signature, in particular cryptographic signature, is created for at least one operating data set and is appended to the corresponding unencrypted operating data set in order to achieve anti-tamper protection for the operating data set. In one method step, in particular the protection step 116a, the signature data are created and/or encrypted by asymmetric encryption, in this case for example using an Elliptic Curve Cryptography (ECC) algorithm or a Rivest-Shamir-Adleman (RSA) cryptography algorithm.

In repeated method steps, in particular a plurality of data set steps 114a, the data set generator 30a compiles a plurality of operating data sets relating to the display device 10a, in particular at periodic time intervals relative to one another. The method 100a is preferably carried out repeatedly at periodic time intervals such as 10 s, 5 s, 1 s or the like.

In one method step, in particular a recorder step 118a, an at least partially encrypted and/or cryptographically signed operating data set is stored, in particular on the recorder unit 50a.

The cryptography component 32a is designed to create at least one operating data set, in particular a plurality of operating data sets, and/or at least one operating entered-data set, in particular a plurality of operating entered-data sets, from an operation of the display device 10a, and to impart anti-tamper protection to, in particular to cryptographically sign and/or at least partially encrypt, the operating data set, in particular operating data sets, and/or the operating entered-data set, in particular operating entered-data sets.

The safety system 40a comprises the data set generator 30a. The safety system 40a comprises the checking unit 20a. The checking unit 20a is designed to generate comparison data from a comparison of input data with output data. The safety system 40a comprises the recorder unit 50a. The recorder unit 50a is designed to store the operating data set and/or the operating entered-data set.

The safety system 40a comprises a data backup interface 36a, which is designed to output the operating data set to the recorder unit 50a.

The display device 10a comprises the safety system 40a. The safety system 40a is designed so as to be separable from the display device 10a. In particular, the safety system 40a is configured for example as a card module which can be retroactively integrated into/coupled to existing display devices. An operator control terminal 70a comprises the display device 10a. The operator control terminal 70a comprises, for example, the safe computing unit 12a. The operator control terminal 70a does not need to comprise the safe computing unit 12a.

A vehicle (not shown), in particular rail vehicle, may comprise the operator control terminal 70a. A signal box (not shown) for controlling a railway system may comprise the operator control terminal 70a. A control station (not shown) for process control in an industrial plant may comprise the operator control terminal 70a. By way of example, in this case, a vehicle comprises the operator control terminal 70a having the display device 10a.

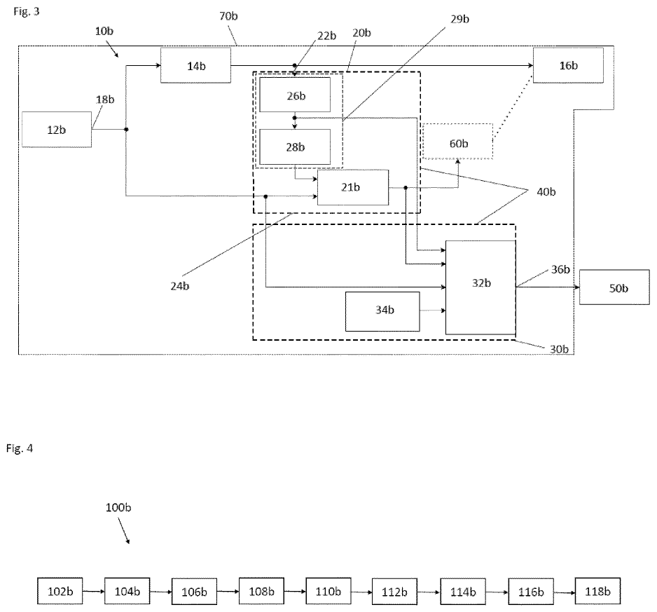

FIGS. 3, 4, 5, 6, 7 and 8 show further exemplary embodiments of the invention. The following descriptions and the drawings are limited substantially to the differences between the exemplary embodiments, wherein, with regard to identically designated components, in particular with regard to components having the same reference signs, reference may in principle also be made to the drawings and/or to the description of the other exemplary embodiments, in particular of FIGS. 1 to 2. In order to distinguish between the exemplary embodiments, the alphabetic character a has been appended as a suffix to the reference signs in the exemplary embodiment in FIG. 1 to . . . . In the exemplary embodiments in FIGS. 3 to 8, the alphabetic character a has been replaced with the alphabetic characters b to d.

FIG. 3 shows an alternative display device 10b. FIG. 3 shows, in particular, a recorder unit 50b. The recorder unit 50b is designed to store created, cryptographically signed and/or at least partially encrypted operating data sets. The recorder unit 50b is formed and arranged externally with respect to a safety system 40b. The recorder unit 50b is formed and arranged externally with respect to an operator control terminal 70b.

A data set generator 30b is connected to a checking unit 20b for a transfer of comparison data. The data set generator 30b, in particular a cryptography component 32b, is directly connected to a recovery unit 29b, in particular a first recovery component 26b, for a transmission of fingerprint data determined from the output data in the form of image data. In particular, the recovery unit 29b, in particular the checking unit 20b, is directly connected to the data set generator 30b, in particular the cryptography component 32b, for data transfer.

In this example, the checking unit 20b and the data set generator 30b form a common safety system 40b, wherein the checking unit 20b and the data set generator 30b are formed as different, in particular mutually complementary, modules on different boards or circuit boards, which are in particular each formed separately from an image computing unit 14b.

A vehicle (not shown), in particular rail vehicle, may comprise the operator control terminal 70b. A signal box (not shown) for controlling a railway system may comprise the operator control terminal 70b. A control station (not shown) for process control in an industrial plant may comprise the operator control terminal 70b. By way of example, in this case, the signal box comprises the operator control terminal 70b having the display device 10b.

FIG. 4 schematically shows a method 100b for creating an operating data set during operation of a display device 10b.

The method 100b differs from the method 100a of the first example by a method step, in particular a transmission step 110b, in that the output data are not transferred, in the form of the process value generated from image data by the recovery unit 29b, to the data set generator 30b, in particular the cryptography component 32b, and instead the output data are transferred, in the form of the fingerprint data generated from image data by the first recovery component 26b, from the recovery unit 29b to the data set generator 30b, in particular the cryptography component 32b.

In three method steps, an output data step 106b, a recovery step 108b and the transmission step 110b, the output data are, in the form of fingerprint data recovered from the output data, transferred from an image computing unit 14b to a comparison component 21b. In one method step, in particular the transmission step 110b, the output data are transferred, in the form of fingerprint data generated from image data by the recovery unit 29b, in particular the first recovery component 26b, to the cryptography component 32b.

In one method step, in particular the transmission step 110b, the output data are transmitted from the computing unit, in particular the image computing unit 14b, via the recovery unit 29b to the data set generator 30b, in particular to the cryptography component 32b.

In one method step, in particular a data set step 114b, the fingerprint data are incorporated as output data into the operating data set.

FIG. 5 shows an alternative display device 10c. A data set generator 30c is connected to a checking unit 20c for a transfer of comparison data. The data set generator 30c, in particular a cryptography component 32c, is directly connected to an image computing unit 14b for a transmission of output data in the form of image data. In particular, a recovery unit 29c, in particular a first recovery component 26c and/or a second recovery component 28c, is not connected directly to the data set generator 30c, in particular the cryptography component 32c. The image computing unit 14c is connected directly to the data set generator 30c, in particular the cryptography component 32c, for a transmission of the output data in the form of image data.

A vehicle (not shown), in particular rail vehicle, may comprise an operator control terminal 70c. A signal box (not shown) for controlling a railway system may comprise the operator control terminal 70c. A control station (not shown) for process control in an industrial plant may comprise the operator control terminal 70c. By way of example, in this case, the control station comprises the operator control terminal 70c having the display device 10c.

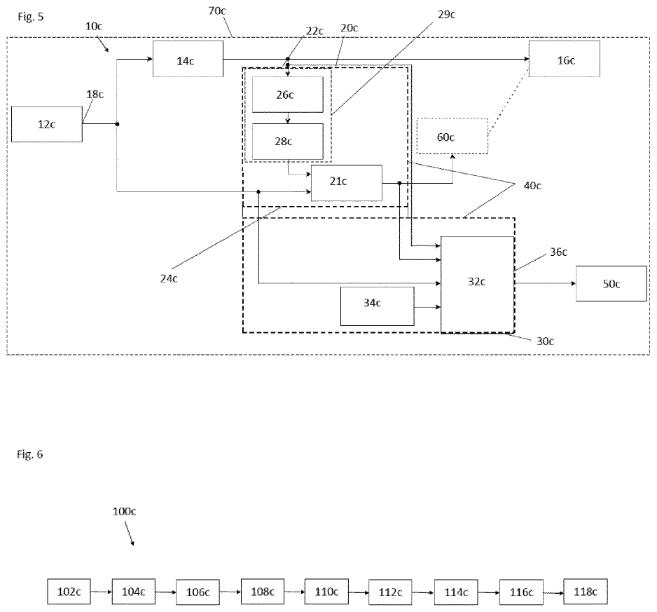

FIG. 6 schematically shows a method 100c for creating an operating data set during operation of a display device 10c.

The method 100c differs from the method 100a of the first example by a method step, in particular by a transmission step 110c, in that the output data are not transferred, in the form of the process value generated from image data by a recovery unit 29c, in particular a first recovery component 26c, and a second recovery component 28c, to the cryptography component 32c, and by an output data step 106c, in which the output data are transferred, in the form of image data, to the data set generator 30c, in particular to the cryptography component 32b.

In one method step, in particular the output data step 106c, the output data are transmitted, in the form of image data, from the computing unit, in particular the image computing unit 14c, to the data set generator 30b, in particular to the cryptography component 32b.

In one method step, in particular a data set step 114c, the image data are incorporated as output data into the operating data set.

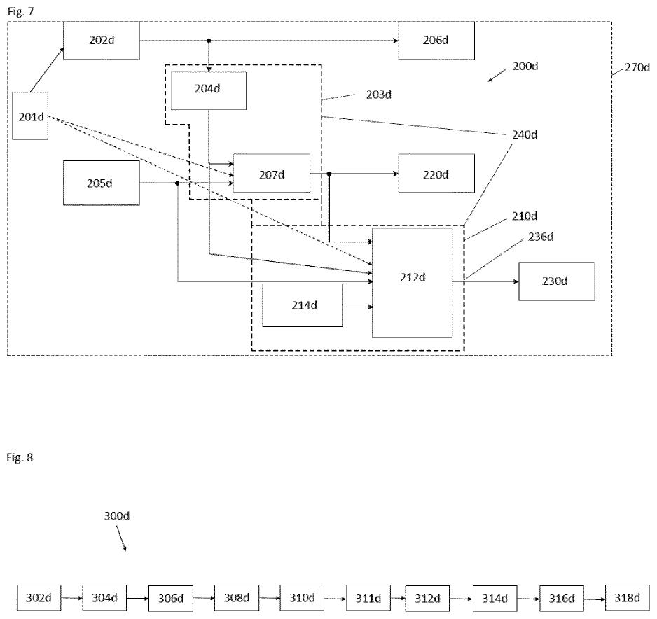

FIG. 7 shows an alternative display device 200d. The display device 200d comprises an entry unit 205d. The display device 200d comprises a display unit 206d. The entry unit 205d is arranged on the display unit 206d. In particular, the display device 200d comprises a touchscreen display. The touchscreen display is formed by the display unit 206d and by the entry unit 205d arranged on the display unit 206d. The display device 200d comprises a computing unit, in particular the image computing unit 202d. The image computing unit 202d is connected to the display unit 206d of the display device, in particular for a transfer of the output data to the display unit 206d.

The display device 200d comprises a further computing unit, in particular a checking unit 203d. The checking unit 203d is designed to generate entry verification data from a merging at least of entered data and output data. The display device 200d comprises a recovery unit 204d and a comparison component 207d according to the preceding examples. The display device 200d comprises an additional computing unit, in particular a data set generator 210d. The additional computing unit, in particular the data set generator 210d, comprises the cryptography component 212d. The display device 200d is coupled to an auxiliary computing unit, in particular to a safe computing unit 201d, preferably to a safety programmable controller (SPC). The data set generator 210d has an index unit 214d. The index unit 214d is designed to provide and/or output index data, for example incremental counter data, for each operating entered-data set. The safe computing unit 201d is for example coupled to the data set generator 210d, in particular the cryptography component 212d, and the checking unit 203d, in particular the comparison component 207d, for a transfer of the input data.

For example, the further computing unit, in particular the checking unit 203d, and the additional computing unit, in particular the data set generator 210d, are formed as one computing unit, in particular as one safety system 240d, preferably on a common board or circuit board, which is in particular formed and/or arranged separately from, preferably as a separate component with respect to, the computing unit, in particular the image computing unit 202d. The display device 200d comprises a data sink 220d.

FIG. 8 schematically shows a method 300d for creating an operating entered-data set during operation of the display device 200d.

In one method step, in particular an input data step 302d, safe input data are transferred to the image computing unit 202d in order to generate presentable output data. In one method step, in particular the input data step 302d, safe input data are transferred to the checking unit 203d. In one method step, in particular the input data step 302d, safe input data are transferred to the data set generator 210d, in particular the cryptography component 212d. The input data are configured in the form of process values. The input data are generated by the safe computing unit 12a.

In one method step, in particular a generation step 304d, presentable output data, in particular image data, are generated from the input data by the image computing unit 202d.

In one method step, in particular an output data step 306d, the output data are transferred from the image computing unit 302d to the checking unit 203d. In one method step, in particular the output data step 106a, the output data are transferred from the image computing unit 302d to the display unit 206d, in particular the display of the touchscreen display.

In at least one method step, in particular in a recovery step 308d, the output data are converted by the recovery unit 204d firstly into a fingerprint and then into a recovered process value. In at least one method step, in particular the recovery step 308d, the output data in the form of image data are converted into fingerprint data and/or process values, in particular by means of the recovery component 204d.

In at least one method step, in particular in a transmission step 310d, the output data are, in the form of the process value recovered from the output data, transferred from the recovery unit 204d to the comparison component 207d of the checking unit 203d. In at least one method step, in particular in the transmission step 310d, the output data are transferred, in particular in the form of the process value generated from image data by the recovery unit 204d, from the checking unit 203d to the data set generator 210d, in particular the cryptography component 212d.

In one method step, in particular a capturing step 311d, entries, in this case for example touch entries, made at the entry unit 205d are captured by reading out the entry unit 205d as entered data. In one method step, in particular the capturing step 311d, the input data are transferred to the checking unit 203d. In one method step, in particular the capturing step 311d, the input data are transferred to the data set generator 210d, in particular the cryptography component 212d.

In one method step, in particular a merging step 312d, the checking unit 203d generates entry verification data by virtue of at least the entry data and the output data being merged by the checking unit 203d, in particular the comparison component 207d. In one method step, in particular the merging step 312d, the entry verification data are transferred to the data set generator 210d, in particular to the cryptography component 212d. In one method step, in particular the merging step 312d, index data are transferred to the data set generator 210d, in particular to the cryptography component 212d. The merging step 312d may contain the comparison step 112a-c from the preceding examples.

In one method step, in particular a data set step 314d, the data set generator 30a compiles an operating entered-data set with operating entered data relating to the display device 200d.

In one method step, in particular the data set step 314d, in the compiling of the operating entered-data set, the entry verification data, the index data, the entered data and optionally the comparison data, and optionally the output data, and optionally the input data are incorporated into the operating entered-data set. In one method step, in particular the data set step 114a, the output data are incorporated in the form of process values into the operating entered-data set.

In one method step, in particular a protection step 316d, the data set generator 210d, in particular the cryptography component 212d, imparts anti-tamper protection, for example a cryptographic signature, to the operating entered-data set, in particular in order to provide a tamperproof operating entered-data set. In one method step, in particular the protection step 316d, the data set generator 210d, in particular the cryptography component 212d, forms signature data, for example hashed data, from the other data in the operating entered-data set. In one method step, in particular the protection step 316d, the data set generator 210d, in particular the cryptography component 212d, forms the signature data, for example as hashed data, by means of a hashing algorithm. In one method step, in particular the protection step 316d, the data set generator 210d, in particular the cryptography component 212d, at least partially encrypts the operating entered-data set, in particular encrypts the signature data of the operating entered-data set, in order to achieve anti-tamper protection for the operating entered-data set, in particular in order to provide a tamperproof operating entered-data set. In one method step, in particular the protection step 316d, the signature data are encrypted in order to achieve anti-tamper protection for the operating entered-data set. In one method step, in particular the protection step 316d, the signature data, for example hashed data, are formed by means of a hashing algorithm. In one method step, in particular the protection step 316d, a digital signature, in particular cryptographic signature, is created in at least one operating entered-data set and is appended to the corresponding unencrypted operating entered-data set in order to achieve anti-tamper protection for the operating entered-data set. In one method step, in particular the protection step 316d, the signature data are created and/or encrypted by asymmetric encryption, in this case for example using an Elliptic Curve Cryptography (ECC) algorithm or a Rivest-Shamir-Adleman (RSA) cryptography algorithm.

The protection step 316d comprises an at least partial encryption of the operating entered-data set by means of the cryptography component 212d, in particular by asymmetric encryption, in this case for example using an Elliptic Curve Cryptography (ECC) algorithm or a Rivest-Shamir-Adleman (RSA) cryptography algorithm.

In repeated method steps, in particular a plurality of data set steps 314d, the data set generator 210d compiles a plurality of operating entered-data sets relating to the display device 200d, in particular at periodic time intervals relative to one another. The method 300d may for example be carried out repeatedly in full every time an entry, for example touch entry, is made, that is to say upon instigation. In the absence of any entry being made, the method 300d may be carried out repeatedly in part, in particular in order to create an operating data set in accordance with a first aspect of the invention. At least when an entry, in particular touch entry, is made, the method 300d is carried out repeatedly in full.

In one method step, in particular a recorder step 318d, an encrypted operating entered-data set is stored, in particular on the recorder unit 230d.

The cryptography component 210d is designed to create at least one operating entered-data set, in particular a plurality of operating entered-data sets, from an operation of the display device 200d, and to impart anti-tamper protection to the operating entered-data set, in particular operating entered-data sets.

A safety system 240d comprises the data set generator 210d. The safety system 240d comprises the checking unit 203d. The checking unit 203d is designed to generate the entry verification data from a merging at least of the entered data and the output data.

An operator control terminal 270d comprises the display unit 200d and a recorder unit 230d. The recorder unit 230d is formed externally with respect to the safety system 240d. The recorder unit 230d is formed externally with respect to the display device 200d. The recorder unit 230d is designed to store the operating entered-data set. The safety system 240d comprises a data backup interface 236d, which is designed to output the operating entered-data set to the recorder unit 230d.

The display device 200d comprises the safety system 240d. The safety system 240d is designed so as to be separable from the display device 200d. In particular, the safety system 240d is configured for example as a card module which can be retroactively integrated into/coupled to existing display devices 200d. An operator control terminal 270d comprises the display device 200d. The operator control terminal 270d comprises, for example, the safe computing unit 201d.

A vehicle (not shown), in particular rail vehicle, may comprise the operator control terminal 270d. A signal box (not shown) for controlling a railway system may comprise the operator control terminal 270d. A control station (not shown) for process control in an industrial plant may comprise the operator control terminal 270d.

### LIST OF REFERENCE SIGNS

10 Display device
12 Safe computing unit
14 Image computing unit
16 Display
18 Input interface
20 Checking unit
21 Comparison component
22 Image interface
24 Data set interface
26 Recovery component
28 Recovery component
29 Recovery unit
30 Data set generator
32 Cryptography component
34 Index unit
36 Data backup interface
40 Safety system
50 Recorder unit
60 Reaction unit
70 Operator control terminal
100 Method
102 Input data step
104 Generation step
106 Output data step
108 Recovery step
110 Transmission step
112 Comparison data step
114 Data set step
116 Protection step
118 Recorder step
200 Display device
202 Image computing unit
203 Checking unit
204 Recovery unit
205 Input unit
206 Display unit
207 Comparison component
210 Data set generator
212 Cryptography component
214 Index unit
220 Data sink
230 Recorder unit
236 Data security interface
240 Safety system
270 Operator control terminal
300 Method
302 Input data step
304 Generation step
306 Output data step
308 Recovery step
310 Transmission step
311 Capturing step
312 Merging step
314 Data set step
316 Protection step
318 Recorder step

1. A method for creating a tamperproof operating data set during operation of a display device (10a-c, 200d), the method comprising:
transferring input data to a computing unit (14a-c, 202d) in order to generate presentable output data,
transferring the output data to a checking unit (20a-c, 203d),
transferring the input data to the checking unit (20a-c, 203d),
generating, by means of the checking unit (20a-c, 203d), comparison data from a comparison of the input data with the output data,
characterized by
compiling data to form the operating data set, which comprises at least two of the following three data, specifically input data, output data and/or comparison data, by means of a cryptography component (32a-c, 212d), and
tamperproofing the operating data set by means of the cryptography component (32a-c, 212d) in order to provide the tamperproof operating data set.

2. The method as claimed in claim 1, characterized in that the output data are transferred, in the form of image data, to the cryptography component (32a-c, 212d).

3. The method as claimed in claim 2, characterized in that the image data comprise video data.

4. The method at least as claimed in claim 1, characterized in that the output data are transferred, in the form of fingerprint data generated from image data by a computing unit (29a-c, 204d), to the cryptography component.

5. The method at least as claimed in claim 1, characterized in that the output data are transferred, in the form of a process value generated from image data by a computing unit (29a-c, 204d), to the cryptography component (32a-c, 212d).

6. The method at least as claimed in claim 1, characterized in that, in the compiling of the operating data set, all three of the following data from the comparison data, the output data and the input data are incorporated into the operating data set.

7. A method for creating a tamperproof operating entered-data set during operation of a display device (200d) having a display unit (16a-c, 206d) and having an entry unit (205d) arranged on the display unit (206d), the method comprising:
transferring input data to a computing unit (202d) in order to generate presentable output data,
transferring the presentable output data to a checking unit (203d),
capturing an entry, for example a touch entry, made at the entry unit (205d) by reading out the entry unit (205d) as entered data,
transferring the entered data to the checking unit (203d),
generating, by means of the checking unit (203d), entry verification data from a merging at least of the entered data and the output data,
characterized by
merging data to form the operating entered-data set from the entry verification data and the entered data by means of a cryptography component (212d), and tamperproofing the operating entered-data set by means of the cryptography component (212d) in order to provide the tamperproof operating entered-data set.

8. The method as claimed in claim 7, characterized in that, in the compiling of the operating entered-data set, the input data and/or the output data are additionally incorporated.

9. The method at least as claimed in claim 7, characterized in that, in the compiling of the operating entered-data set, comparison data created by means of a checking unit (203d) from a comparison of the input data with the output data are additionally incorporated.

10. The method at least as claimed in claim 1, characterized in that, in the creation of the operating data set or of the operating entered-data set, index data, preferably timestamp data, counting data and/or reference data, are additionally incorporated into the operating data set or the operating entered-data set.

11. The method at least as claimed in claim 1, characterized in that the tamperproofing of the operating data set or of the operating entered-data set is performed at least in part by asymmetrical encryption, preferably using an Elliptic Curve Cryptography (ECC) algorithm or a Rivest-Shamir-Adleman (RSA) cryptography algorithm.

12. The method at least as claimed in claim 1, characterized in that the tamperproof operating data set or the tamperproof operating entered-data set is stored.

13. The method at least as claimed in claim 1, characterized in that the method is, at least in part, carried out repeatedly.

14. A data set generator having a cryptography component (32a-c, 212d), characterized in that the cryptography component (32a-c, 212d) is designed to create an operating data set and/or an operating entered-data set from an operation of a display device (10a-c, 200d), and is designed to impart anti-tamper protection to the operating data set and/or to the operating entered-data set, wherein the data set generator is connectable, for a transfer of input data, to a safe computer, wherein the data set generator is connectable, for a transfer of the input data, entered data and/or output data, to a computing unit, in particular an image computing unit, and/or is connectable, for a transfer of comparison data, entry verification data and/or the output data, to a further computing unit, in particular checking unit, wherein the operating data set comprises at least two of the following three data, specifically input data, output data and/or comparison data, wherein the operating entered-data set is formed at least from the entry verification data and the entered data.

15. A safety system having a data set generator (30a-c, 210d) as claimed in claim 14, characterized by a checking unit (20a-c, 203d) which is designed to generate entry verification data from a merging at least of entered data and output data, and/or to generate comparison data from a comparison of input data with output data.

16. The safety system having a data set generator (30a-c, 210d) as claimed in claim 15, characterized by a recorder unit (50a-c, 230d) which is designed to store the operating data set and/or the operating entered-data set.

17. The safety system having a data set generator (30a-c, 210d) as claimed in claim 15, characterized by a data backup interface (36a-c, 236d) which is designed to output the operating data set and/or the operating entered-data set.

18. A display device having a safety system (40a-c, 240d) as claimed in at least one of claim 15.

19. An operator control terminal having a display device (10a-c, 200d) as claimed in claim 18.

20. A vehicle, in particular rail vehicle, having an operator control terminal (70a-c, 270d) as claimed in claim 19.

21. A signal box for controlling a railway system, having an operator control terminal (70a-c, 270d) as claimed in claim 19, or a control station for process control in an industrial plant, having operator control terminal (70a-c, 270d) as claimed in claim 19.
